(19) United States
(12) Patent Application Publication
(10) Pub. No.: US 2012/0121166 A1
(43) Pub. Date: May 17, 2012

(54) METHOD AND APPARATUS FOR THREE DIMENSIONAL PARALLEL OBJECT SEGMENTATION

(75) Inventors: Dong-Ik Ko, McKinney, TX (US); Victor Cheng, Dallas, TX (US)

(73) Assignee: Texas Instruments Incorporated, Dallas, TX (US)

(21) Appl. No.: 13/295,783

(22) Filed: Nov. 14, 2011

Related U.S. Application Data
(60) Provisional application No. 61/413,259, filed on Nov. 12, 2010.
(60) Provisional application No. 61/413,263, filed on Nov. 12, 2010.
(60) Provisional application No. 61/414,338, filed on Nov. 16, 2010.

(51) Int. Cl. G06K 9/34

(52) U.S. Cl. 382/154

(57) ABSTRACT

A method and apparatus for parallel object segmentation. The method includes retrieving at least a portion of a 3-dimensional point cloud data x, y, z of a frame, dividing the frame into sub-image frames if the sub-frame based object segmentation is enabled,
performing fast parallel object segmentation and object segmentation verification; and performing the 3-dimensional segmentation.

### CROSS-REFERENCE TO RELATED APPLICATIONS

This application claims benefit of U.S. provisional patent application Ser. Nos. 61/413,259 filed Nov. 12, 2010, 61/413,263 filed Nov. 12, 2010, and 61/414,338 filed Nov. 16, 2010, which are herein incorporated by reference.

### BACKGROUND OF THE INVENTION

1. Field of the Invention

Embodiments of the present invention generally relate to a method and apparatus for 3-dimensional parallel object segmentation.

2. Description of the Related Art

Object segmentation in 3-dimensional (3D) vision requires heavy computation bandwidth and is a main bottleneck in obtaining real-time embedded vision applications. Since parameters are dynamically changed based on situations, hard-wired approach is almost impossible to apply. Existing solutions use conditional operations to determine the membership of each element against clustering centroids. This problem prevents applying 3D object segmentation to a full parallelism.

Further more, 3D point cloud (x,y and z coordinate) based object segmentation provides robust segmentation performance compared to 2D based object segmentation. Due to the z coordinate's impact in 3D object segmentation, neighboring points in the x and/or y axes can be grouped to the same segment. This can result in wrong segmentation in terms of human object detection.

In 3D vision applications, a main purpose of object segmentation is to extract human objects from cluttered scene. Existing solutions use an expensive contour search algorithm to detect fine tuned object segmentations. Contouring approach's computation bandwidth becomes heavier as an image size of 3D point clouds increases.

In addition, a fine grained object segmentation with a large number of centroids may need more computation bandwidth than a coarse grained object segmentation with a small sized centroids. On-chip memory size limitation for the large number of centroids makes it almost impossible to apply a parallel processing of object segmentation.

Therefore, there is a need for a method and/or apparatus for improving the 3D parallel object segmentation.

### SUMMARY OF THE INVENTION

Embodiments of the present invention relate to a method and apparatus for parallel object segmentation. The method includes retrieving at least a portion of a 3-dimensional point cloud data x, y, z of a frame, dividing the frame into sub-image frames if the object segmentation is enabled, performing fast parallel object segmentation and object segmentation verification; and performing the 3-dimensional segmentation.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow diagram depicting an embodiment of a method for functional break-down of 3-dimensional object fast parallel segmentation;

FIG. 2 (A-P) are embodiments showing the steps of the method for functional break-down of 3-dimensional object fast parallel segmentation described in FIG. 1;

FIG. 3 (A-B) are embodiments of images depicting point cloud data and 3-dimensional object segmentation;

FIG. 4 (A-B) are embodiments of images depicting 3-dimensional object segmentation correction with face detection;

FIG. 5 is a flow diagram depicting an embodiment of a method for 3-dimensional object segmentation correction with face detection;

FIG. 6 (A-B) are embodiments of images depicting comparison between a full frame based segmentation and sub-image based segmentation;

FIG. 7 is a flow diagram depicting an embodiment of a method for 3-dimensional object segmentation correction with verification of object segmentation and merging ; and

FIG. 8 is a flow diagram depicting an embodiment of a method for improving parallel object segmentation.

### DETAILED DESCRIPTION

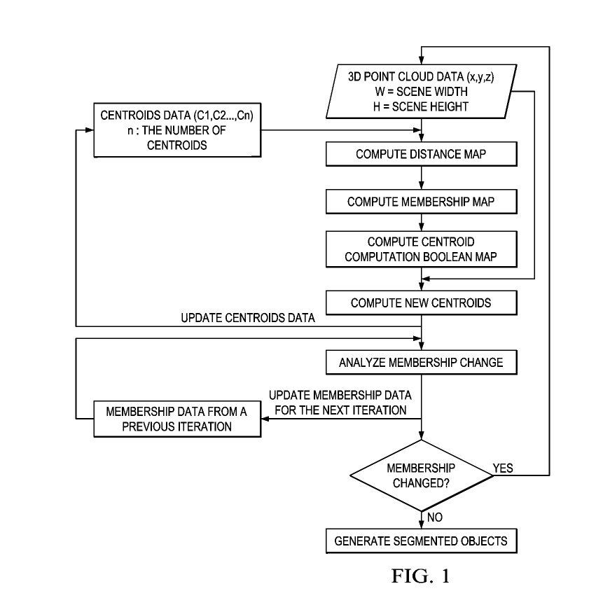

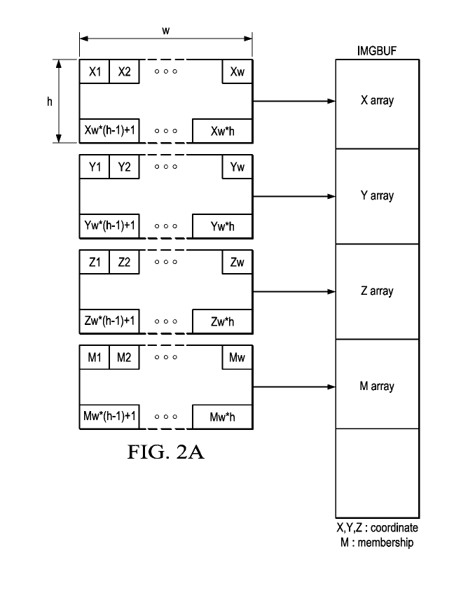

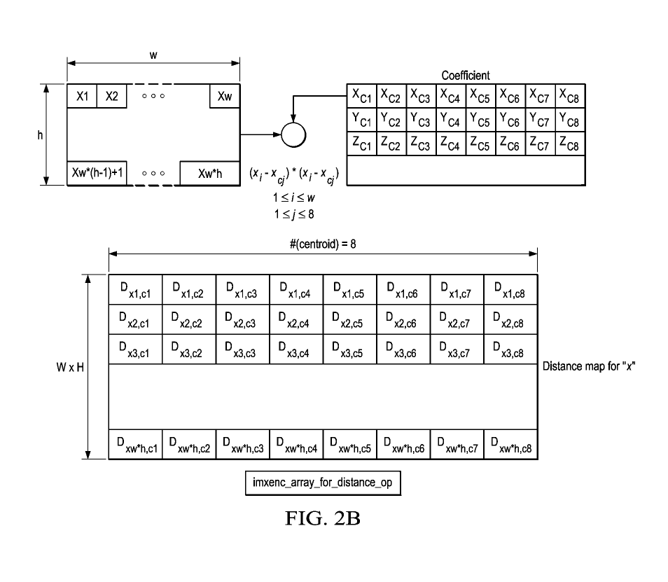

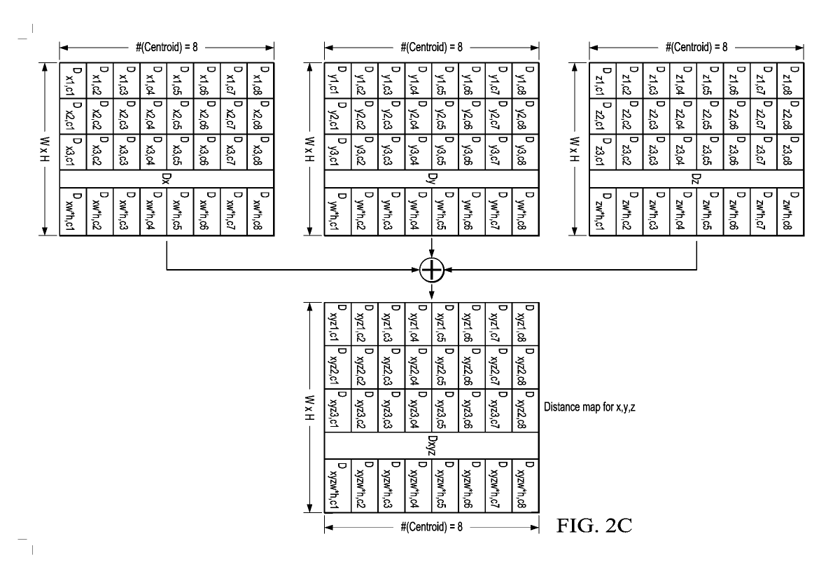

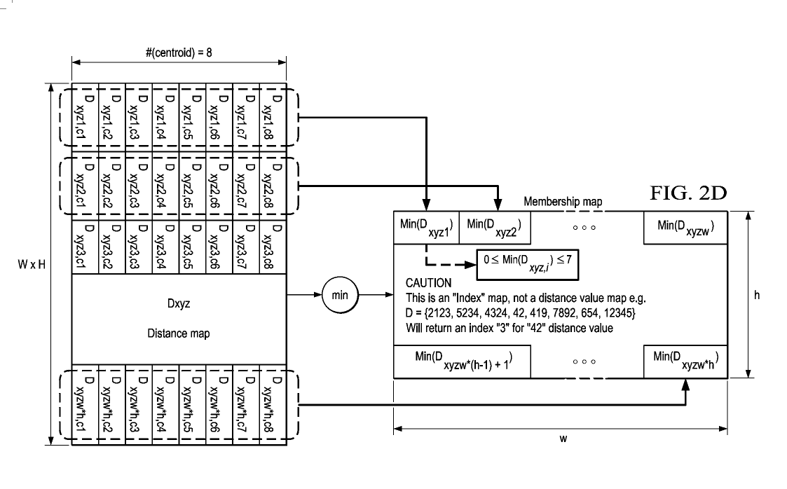

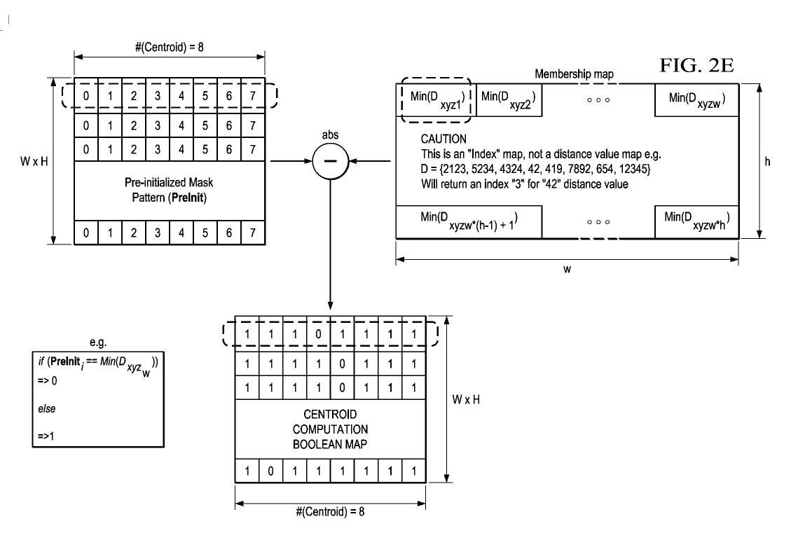

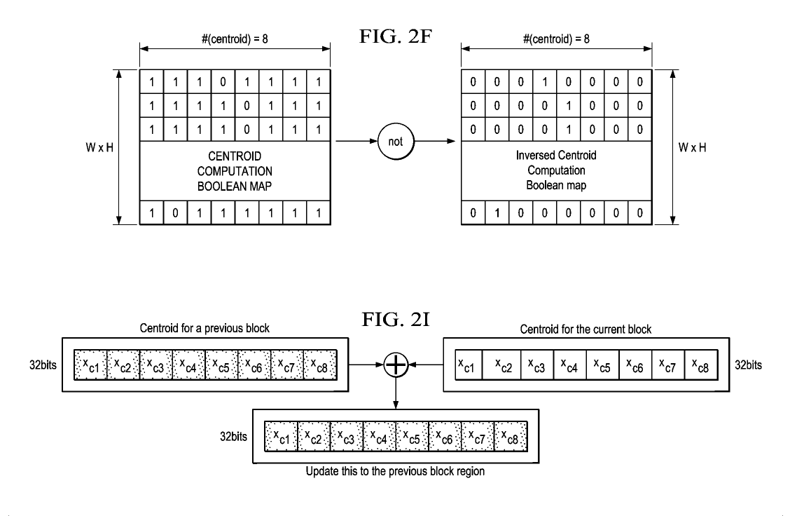

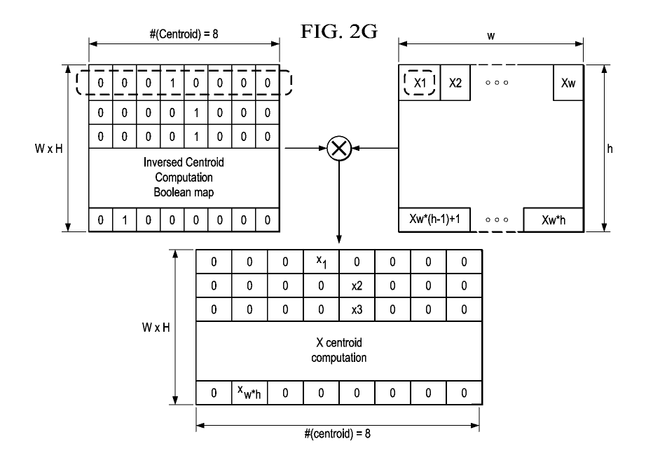

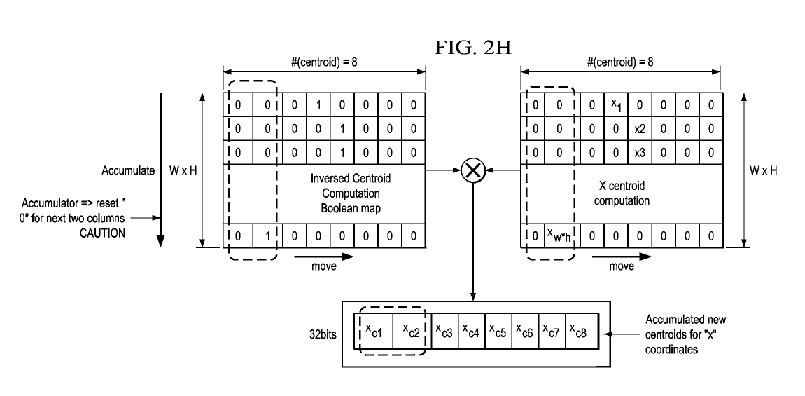

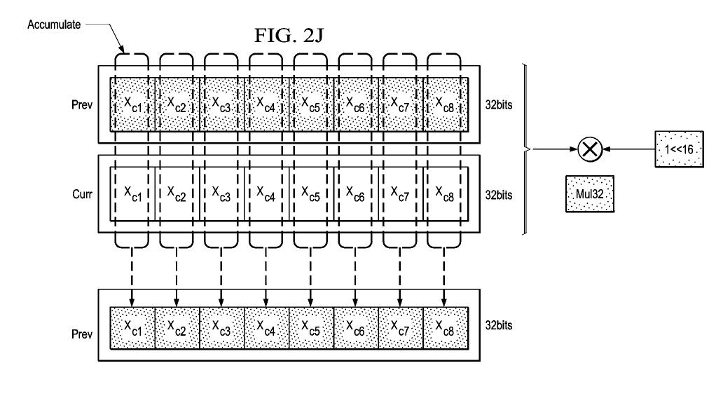

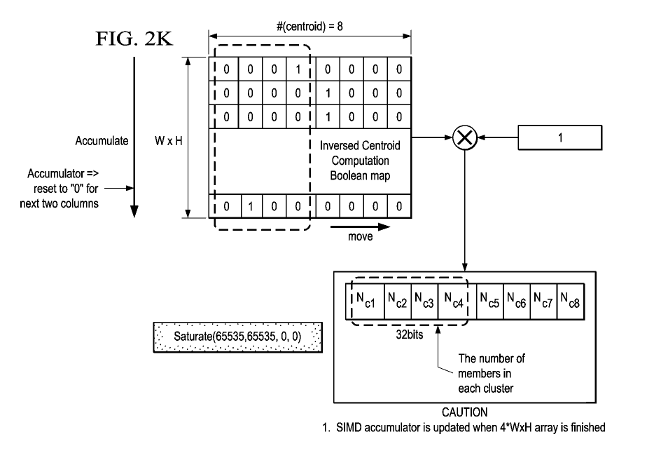

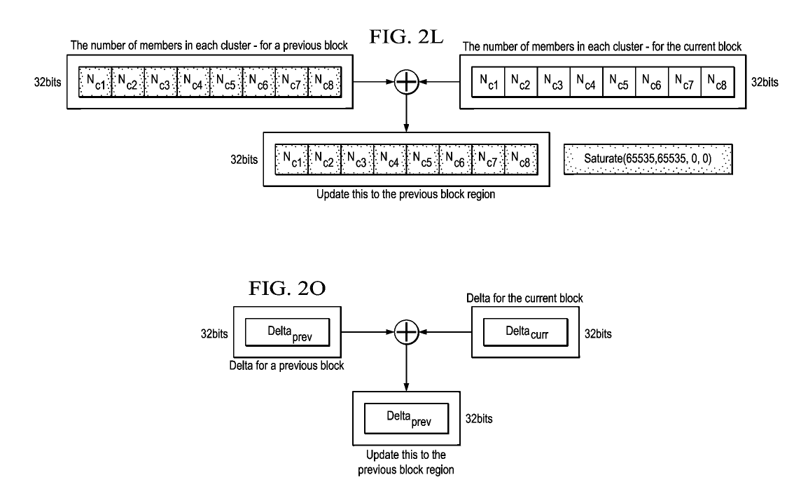

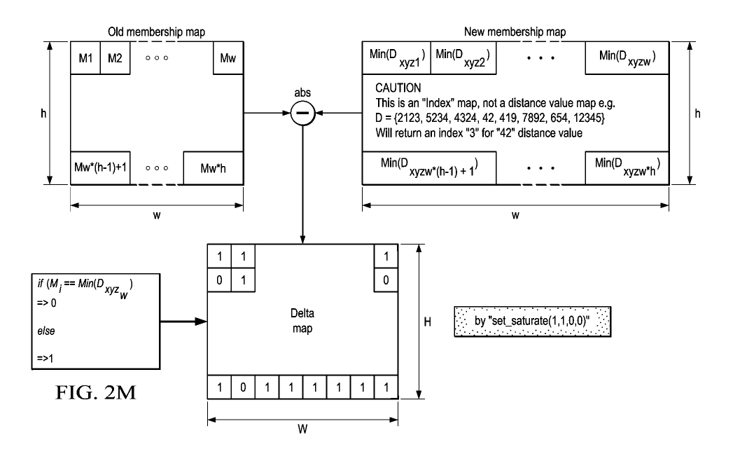

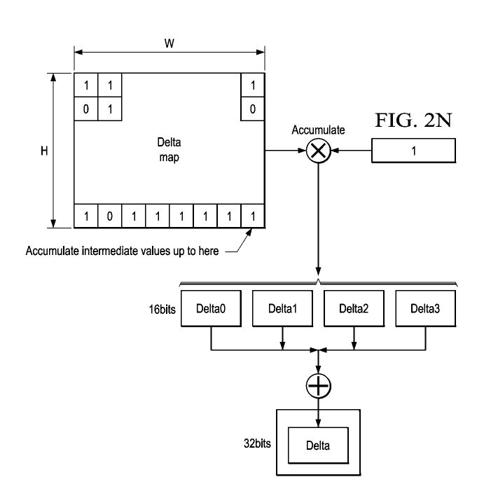

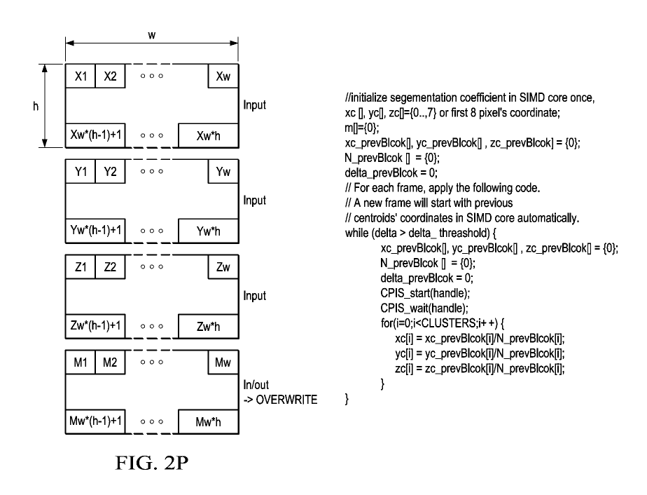

FIG. 1 is a flow diagram depicting an embodiment of a method for functional break-down of 3-dimensional object fast parallel segmentation. FIG. 2 (A-P) are embodiments of a functional break-down of 3-dimensional object fast parallel segmentation. As shown in FIG. 1 and FIG. 2 (A-P), in one embodiment, 3D object parallel segmentation is applied by replacing conditional operation features of segmentation operation, which prevents vector processing of object segmentation with Boolean mask maps.

The method obtains the image and membership, as shown in FIG. 2A, by retrieving the 3-dimensional (3D) point cloud data x, y, z coordinates and the scene width (w) and the scene height (h). The method proceeds to compute the distance map, as shown in FIG. 2B and 2C, from Euclidian distance x, y, z against each centroid. The distance map size is n×W×H, where n is the number of centroids. Next, the method computes the membership map, as shown in 2D and 2E, utilizing the distance map. Thus, the method generates the minimum value from distance (C1 . . . Cn) for each 3D point cloud i^{th} (xi, yi, zi). The membership map size is W×H.

The method computes the centroid computation Boolean map, as shown in FIG. 2F, utilizing the membership map. The centroid computation Boolean map size is n×W×H, where the value is set to “1” for the corresponding membership and to “0” for other columns. As shown in FIG. 2F, 2G and 2H, the new centroid is computed with new C1 . . . Cn values. As shown in FIG. 2I, 2J and 2K, the method updates the centroid data and the membership data for the next iteration. Next, as shown in As shown in FIG. 2L, 2M 2N, and 2P, the method analyzes the membership change utilizing the membership data from the previous iteration. If there is a change, the method returns to the beginning to continue segmentation. Otherwise, the method generates the segment objects.

In such an embodiment, full programmability and hard-wired logic's performance is possible. The following slides show how parallelism is applied to 3D object segmentation.

Existing solutions use conditional operations to determine the membership of each element against clustering centroids. This problem prevents applying 3D object segmentation to a full parallelism. Therefore, a high clock rate CPU is necessary to get real-time performance. Hence, a low clock rate and low cost parallel architecture based processing unit can be applied to 3D object segmentation with a fast performance comparable to dedicated hard-wired logic. As a result, full parallel operations of 3D object segmentation, a full flexibility with programmability, and incomparably fast performance compared to object segmentation on a scalar processing unit are allowed.

In one embodiment, the face detection technique is combined with 3D object segmentation. Such a combination makes 3D object segmentation more robust and reliable in any situation.

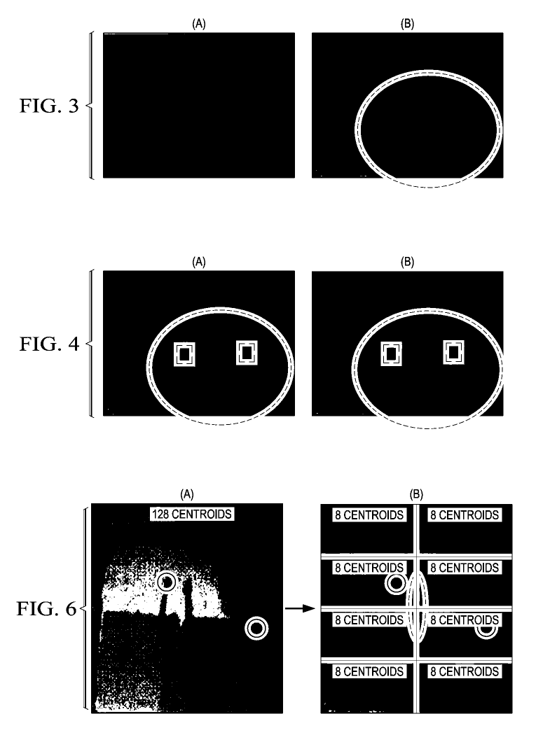

FIG. 3A and 3B is an embodiment of images depicting point cloud data and 3-dimensional object segmentation. In FIG. 3A, the 3D point cloud(x,y z) input array is grouped based on each point's proximity to cluster centers by 3D object segmentation. In FIG. 3B, each 3D point cloud pixel is displayed in different colors depending on their memberships to each object segment. In FIG. 3B, background clutters can be easily extracted from a fore ground human object segment in green color. The problem is two human objects are grouped to the same segment because two human objects are closely located in x and y axes even though they are separated from background clutters in z direction. Whereas, FIG. 4A and 4B are embodiment of images depicting 3D object segmentation correction with face detection. Here, two human objects in the same object segment shown in FIG. 4A are separated into two separate object segments in FIG. 4B.

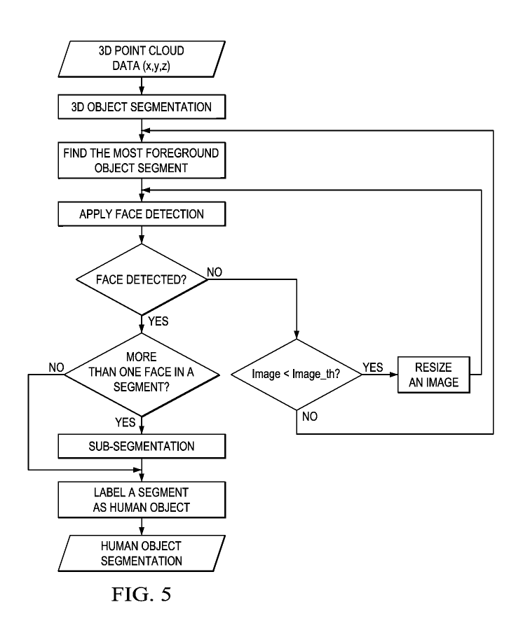

FIG. 5 is a flow diagram depicting an embodiment of a method for 3-dimensional object segmentation correction with face detection. Here, a low resolution of 3D camera can be boosted with a resizing process to increase the reliability of face detection result. The method retrieves the 3D point cloud data x, y, z. The method performs object segmentation utilizing the cloud data. The method finds the most fore ground object segment and applies face detection.

If a face is detected in a segment, the method determines how many faces are in the segment. If there are multiple faces detected, the method performs sub-segmentation; otherwise, the method labels a segment as a human object and performs human object segmentation. If the method does not detect any faces, the method checks if the size is suitable. If not, the method resizes the image and returns to the face detection step. Otherwise, the method returns to the step for finding the most fore ground object in the segments. Such an embodiment, allows for fast and robust 3D object segmentation with a post processing of face detection technique for suspicious object segments and for fast and robust human object segment detection.

In another embodiment, sub-image based object segmentation may utilize SIMD architecture for parallel processing. Post-processing of object segmentation merging process for those objects placed over boundaries of processing blocks can fix sub-image based object segmentation against full frame based object segmentation. This is especially possible when objects are clustered based on their local proximity. Full frame based segmentation for a large number of centroids computes redundant operations in terms of distance measuring computation because most of distance measurement except for centroids locally and closely distributed won't impact segmentation result.

FIG. 6 (A-B) are embodiments of images depicting comparison between a full frame based segmentation and sub-image based segmentation. In FIG. 6, for example, circled object segmentation result may not be changed between full frame based segmentation and sub-image based segmentation. The only issue is objects (in a blue dotted line) placed over boundaries among sub-images. Post-processing of segment merging can remove this problem by comparing the connectivity of wrongly divided segments.

Full frame based object segmentation with a large number of centroids requires inefficient memory access and a large size of on-chip memory. Thus, full flexibility with programmability and a small size on-chip memory with parallel operation on SIMD architecture processor may be used and a full parallel processing of 3D object segmentation are allowed using a large number of centroids.

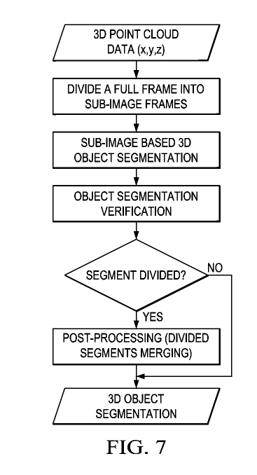

FIG. 7 is a flow diagram depicting an embodiment of a method for 3-dimensional object segmentation correction with verification of object segmentation and merging. As shown in FIG. 7, the method retrieved the 3D point cloud data x,y,z. Then, the method divides full frame into sub-image frames, where the sub-imaging is based on 3D object segmentation. The method verifies the object segmentation. If the segment was divided, the method performs post processing, wherein the divided segments are merged and the like; otherwise, the method performs 3D object segmentation.

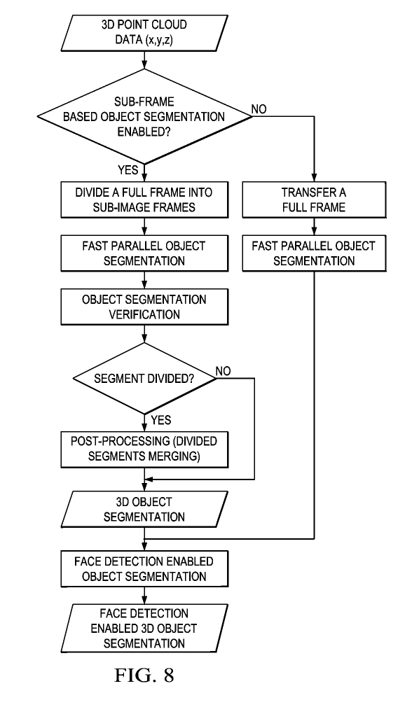

FIG. 8 is a flow diagram depicting an embodiment of a method for improving parallel object segmentation. As shown in FIG. 8, the method retrieves the 3D point cloud data x, y, z. The method determines if sub-frame based on object segmentation is enabled. If it is not enabled, the method transfers the full frame and performs fast parallel object segmentation, for example, as described in FIG. 1, before performing face detection, as described in FIG. 5. If it is enabled, the method divides the full frame into sub-image frames. The method, then, performs fast parallel object segmentation, for example, as described in FIG. 1, and object segmentation verification. The method determines if a segment is divided. If it is divided, the method performs post-processing functions, such as merging the divided segments, before performing the 3D object segmentation, as described in FIG. 7. If the segment is not divided, the method performs the 3D segmentation, as described in FIG. 1.

While the foregoing is directed to embodiments of the present invention, other and further embodiments of the invention may be devised without departing from the basic scope thereof, and the scope thereof is determined by the claims that follow.

What is claimed is:

1. A method of a digital processor for parallel object segmentation, comprising:
retrieving at least a portion of a 3-dimensional point cloud data x, y, z of a frame;
dividing the frame into sub-image frames if the object segmentation is enabled;
performing fast parallel object segmentation and object segmentation verification; and
performing the 3-dimensional segmentation.

2. A method of claim 1, wherein the step of performing fast parallel object segmentation comprises:
applying 3-dimensional object parallel segmentation by replacing conditional operation features of segmentation operation for preventing vector processing of object segmentation with Boolean mask maps;
retrieving the 3-dimensional (3D) point cloud data x, y, z coordinates and the scene width (w) and the scene height (h) for obtaining an image and a membership of the image;
computing the distance map from Euclidian distance x, y, z against a centroid, wherein the distance map size is n×w×h, where n is the number of centroids;
computing the membership map utilizing the distance map and generating the minimum value from distance for each 3D point cloud i^{th} (xi, yi, zi), wherein the membership map size is w×h;
computing a centroid computation Boolean map utilizing the membership map, wherein the centroid computation Boolean map size is n×w×h, where the value is set to “1” for the corresponding membership and to “0” for other columns; and
updating the centroid data and the membership data for the next iteration and analyzing the membership change utilizing the membership data from the previous iteration, wherein when there is a change, continuing segmentation and generating a segment objects when there is no change.

3. The method of claim 1 further comprising:
applying face detection on a foreground object segment;
performing sub-segmentation if more than one face is detected; and
labeling the foreground object segment as a human object segment when a face is detected.

4. An apparatus for parallel object segmentation, comprising:
means for retrieving at least a portion of a 3-dimensional point cloud data x, y, z of a frame;
means for dividing the frame into sub-image frames if the sub-frame based object segmentation is enabled;
means for performing fast parallel object segmentation and object segmentation verification; and
means for performing the 3-dimensional segmentation.

5. The apparatus of claim 4, wherein the means for performing fast parallel object segmentation comprises:
means for applying 3-dimensional object parallel segmentation by replacing conditional operation features of segmentation operation for preventing vector processing of object segmentation with Boolean mask maps;
means for applying retrieving the 3-dimensional (3D) point cloud data x, y, z coordinates and the scene width (w) and the scene height (h) for obtaining an image and a membership of the image;
means for applying computing the distance map from Euclidian distance x, y, z against a centroid, wherein the distance map size is n×w×h, where n is the number of centroids;
means for applying computing the membership map utilizing the distance map;
means for applying generating the minimum value from distance for each 3D point cloud i^{th} (xi, yi, zi), wherein the membership map size is w×h;
means for applying computing a centroid computation Boolean map utilizing the membership map, wherein the centroid computation Boolean map size is n×w×h, where the value is set to “1” for the corresponding membership and to “0” for other columns; and
means for applying updating the centroid data and the membership data for the next iteration and analyzing the membership change utilizing the membership data from the previous iteration, wherein when there is a change, continuing segmentation and generating a segment objects when there is no change.

6. The apparatus of claim 4 further comprising:
means for applying face detection on a foreground object segment;
means for performing sub-segmentation if more than one face is detected; and
means for labeling the foreground object segment as a human object segment when a face is detected.

7. A non-transitory computer storage medium with executable instructions stored therein, when executed performs a method for 3-dimensional object fast parallel segmentation, the method comprising:
retrieving at least a portion of a 3-dimensional point cloud data x, y, z of a frame;
dividing the frame into sub-image frames if the sub-frame based object segmentation is enabled;
performing fast parallel object segmentation and object segmentation verification; and
performing the 3-dimensional segmentation.

8. The non-transitory computer storage medium of claim 7, wherein the step of performing fast parallel object segmentation comprises:
applying 3-dimensional object parallel segmentation by replacing conditional operation features of segmentation operation for preventing vector processing of object segmentation with Boolean mask maps;
retrieving the 3-dimensional (3D) point cloud data x, y, z coordinates and the scene width (w) and the scene height (h) for obtaining an image and a membership of the image;
computing the distance map from Euclidian distance x, y, z against a centroid, wherein the distance map size is n×w×h, where n is the number of centroids;
computing the membership map utilizing the distance map and generating the minimum value from distance for each 3D point cloud i^{th} (xi, yi, zi), wherein the membership map size is w×h;
computing a centroid computation Boolean map utilizing the membership map, wherein the centroid computation Boolean map size is n×w×h, where the value is set to “1” for the corresponding membership and to “0” for other columns; and
updating the centroid data and the membership data for the next iteration and analyzing the membership change utilizing the membership data from the previous iteration, wherein when there is a change, continuing segmentation and generating a segment objects when there is no change.

9. The non-transitory computer storage medium of claim 7 further comprising:
applying face detection on a foreground object segment;
performing sub-segmentation if more than one face is detected; and
labeling the foreground object segment as a human object segment when a face is detected.
